(19) United States
(12) Patent Application Publication
(10) Pub. No.: US 2017/0013824 A1
(43) Pub. Date: Jan. 19, 2017

(54) WEARABLE DEVICE AND SYSTEM FOR CHEMICALLY REPELLING SHARKS

(71) Applicant: William H. Jackson, Wilmington, NC (US)

(72) Inventor: William H. Jackson, Wilmington, NC (US)

(21) Appl. No.: 15/204,332

(22) Filed: Jul. 7, 2016

Related U.S. Application Data
(60) Provisional application No. 62/193,740, filed on Jul. 17, 2015.

(51) Int. Cl. A01M 29/12; A01N 37/44; A01N 63/00; A01N 25/34; A01N 25/04

(52) U.S. Cl. CPC A01M 29/12; A01N 25/34; A01N 25/04; A01N 63/00; A01N 37/44

(57) ABSTRACT

The wearable device and system for chemically repelling sharks includes a water permeable case permanently attached to an adjustable strap for wearing on a user's wrist or ankle. The case receives a refill containing a repellent in a water dissolvable matrix. The refill is retained within the case and dissolves while the user is in water, thereby slowly and consistently releasing the repellent into the surrounding water.

### CROSS-REFERENCE TO RELATED APPLICATIONS

This application claims priority from the United States provisional patent application entitled WEARABLE DEVICE AND SYSTEM FOR CHEMICALLY REPELLING AQUATIC ANIMALS, which was filed on Jul. 17, 2015, and assigned the Ser. No. 62/193,740.

### BACKGROUND OF THE INVENTION

Field

The present invention relates to water safety devices, and more specifically, to a device for wearing on a wrist or ankle that diffuses a chemical for repelling sharks.

Related Art

While it is generally accepted that the risk of injury or death due to a shark attack is statistically low, many people will not go into the ocean because of their fear. People who avoid the ocean miss out on opportunities for recreation, fitness, social bonding, education, and may hesitate to assist a person who is struggling in the water. Thus, it is advantageous for people to reduce or eliminate the fear of shark attacks so they may more comfortably enter and enjoy the ocean.

Different methods and devices have been employed to lessen the risk of a shark attack. For example, shark attacks are more likely to occur during peak feeding time (dusk and dawn), when fish populations are higher than normal, near piers, and where people are shark fishing. Accordingly, many people avoid the ocean when these conditions are present. While this may lessen the likelihood of attack, it is unduly restrictive and not necessarily effective.

In addition, there are devices that purportedly deter sharks using electrical signals, acoustical playbacks, and magnetic forces. However, these devices are typically expensive, not well proven, and/or are ineffective against certain shark species such as the Great White.

Various chemical shark repellents are known, including compounds disclosed in US Patent Application Publication 2010/0016346, entitled ELASMOBRANCH-REPELLING DOMPOUNDS [sic] AND METHODS OF USE, which is hereby incorporated by reference. In addition, it is well established that sharks will avoid an area where they smell chemicals released by dead and dying sharks. For that reason biological material is harvested from dead sharks, and that biological material is putrefied and purified to make “dead shark extract” formulations, which contain necromones, which are effective repellents.

However, there is a need for a device, system and method for chemically repelling aquatic animals, and in particular sharks, that can be worn by an individual. It is desirable that such a device and method is effective, easy to use, economical, and easy to transport.

### SUMMARY OF THE INVENTION

The wearable device and system for chemically repelling sharks includes a water permeable case permanently attached to an adjustable strap for wearing on a user's wrist or ankle. The case receives a refill containing a repellent in a water dissolvable matrix. The refill is retained within the case and dissolves while the user is in water, thereby slowly and consistently releasing the repellent into the surrounding water. The repellent preferably contains necromones.

### BRIEF DESCRIPTION OF THE DRAWINGS

FIG. 1 is a top view of an embodiment of the invention;

FIG. 2 is a side view of the embodiment depicted in FIG. 1;

FIG. 3 is a side view of an embodiment having an alternative fastening means;

FIG. 4 depicts a case in the open position;

FIG. 5 illustrates a refill;

FIG. 6A-6C depict the steps associated with preparing the device for use, including:

FIG. 6A—inserting refill into case;

FIG. 6B—closing door; and

FIG. 6C—inserting distal end of strap into cinching means;

FIG. 7 depicts the device on a user's wrist;

FIG. 8 depicts the device on a user's ankle;

FIG. 9 illustrates an alternative embodiment of the invention; and

FIG. 10 illustrates an individual wearing the device, and the repelling effect that the device has on a shark in proximity to the device.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The following structure numbers shall apply to the following structures among the various FIGS.:

10—Device;

20—Strap;

30—Fastening means;

32a—Hook and loop fastener;

32b—Corresponding hook and loop fastener;

34—Proximal end

35—Distal end;

40—Cinching means;

50—Case

52—Door;

53—Aperture;

54—Base;

56—Hinge;

58—Closure;

60—Refill;

62—Repellent;

64—Matrix;

110—Alternative device;

120—Alternative strap; and

130—Alternative fastening means.

Broadly, the device of the present invention includes a water permeable case permanently attached to an adjustable strap for wearing on a user's wrist or ankle. The case receives a refill consisting of a repellent in a dissolvable matrix. The refill is retained within the case and dissolves while the user is in water, thereby slowly and consistently releasing the repellent into the surrounding water.

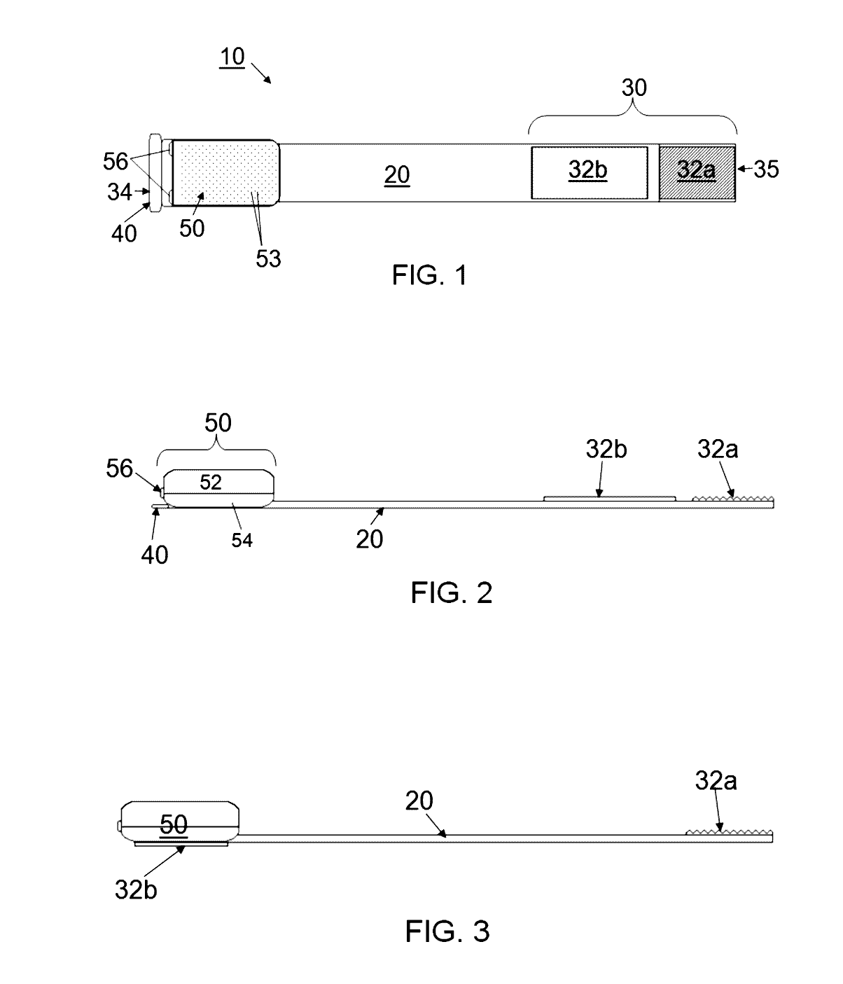

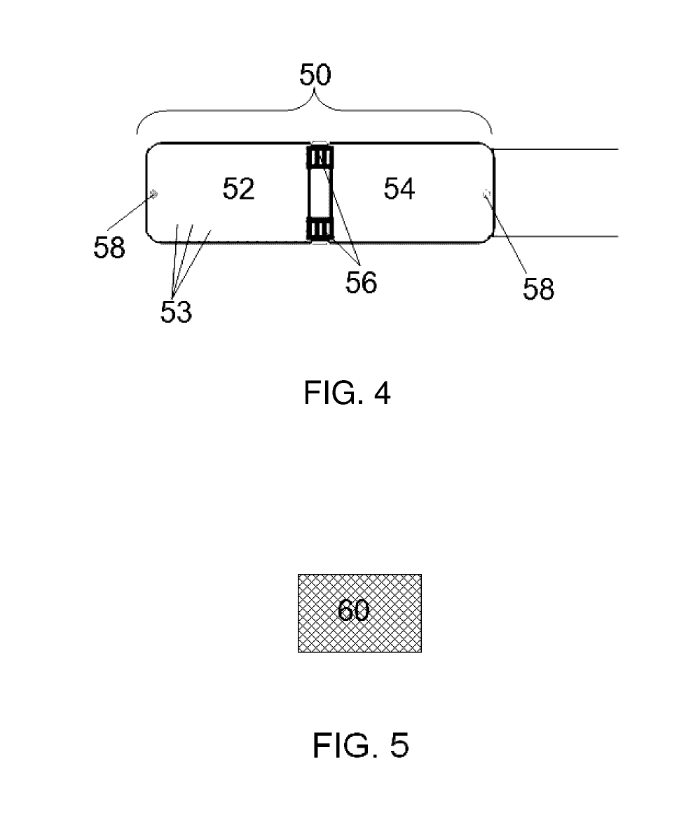

As shown in FIG. 1, device 10 includes proximal end 34 with case 50, and distal end 35 with fastening means 30. As shown best in FIG. 4, case 50 preferably includes door 52 which is permeable to water, salt water, and dissolved refill. Permeability is preferably achieved by apertures 53, but other means for permeability, such as a membrane, could also be employed. Door 52 is rotatably connected to base 54 by hinges 56. It is preferred that base 54 is impermeable to water so contents of refill 60 don't come in direct contact with a user's skin. Case 50 preferably includes closure 58, which is preferably a ball-and-socket closure, although clasps, latches and the like are also within the scope of the invention.

The embodiment of FIG. 1 includes a fastening means whereby hook/loop fastener 32a is positioned nearby corresponding hook/loop fastener 32b, such that the hook/loop fasteners mate one-with-another in use. More specifically, distal end 35 is inserted into gap of cinching means 40, double-backed towards strap 20, then secured by mating hook/loop fasteners 32a and 32b. Strap 20 is preferably constructed of conventional vinyl strapping material that is not easily damaged by salt water.

An alternative fastening means is depicted in FIG. 3 wherein corresponding hook/loop fastener 32b is positioned on the underside of case 50, such that strap 20 would simply loop back onto itself for mating by hook/loop fasteners 32a and 32b. There is no cinching means 40 in this embodiment.

Fastening means could be other known systems such as snaps, buttons, buckles, zippers, adhesives, hooks, ties, and so forth. It is preferred that the fastening means allows the length of the strap to be adjustable in order to fit snugly around different sized wrists, ankles, and so forth.

Refill 60, depicted in FIG. 5, is sized and shaped to fit within hollow case 50. Refill 60 preferably contains repellant 62 suspended in water soluble matrix 64. Preferably repellant 62 is necromone-based, and is effective against both lamniform and carcharhiniformes orders of sharks. One preferred necrome-based repellant is commercially available as Anti Shark 100 from Shark Tec LLC of Lynbrook, N.Y.

Anti Shark 100 is a proprietary formulation having putrefied shark tissue extracts that contains necronomes. Instrumental analysis has been employed to help elucidate the chemical characteristics of these necronomes. More specifically, gas chromatography was used to separate the shark necromone, then time of flight mass spectrometry identified amino acids and organic acids in the shark necromone.

Instrumental analysis indicates the presence of hundreds of volatile components. The necromone has a dominant ammoniacal odor due to short chain volatile amines, predominantly 2-methyl-1-butanamine and 2-butanamine.

Amines are the result of decarboxylation of amino acids during putrefaction. For example, 2-pentanamine is present and is a plausible decarboxylation product of leucine. These short chain amines possess high pKa's, typically greater than 9.0, and are likely the source of the basicity of the necromone mixture. Trimethylamine is present as the osmoregulatory compound trimethylamine-n-oxide (TMAO) is abundant in elasmobranchs. The basic trimethylamine (pKa 9.8) is produced by the bacterial reduction of TMAO during putrefaction. Short chain amines resulting from decarboxylation of amino acids are unlikely to be the specific necromone actives, as bony fish also contain the common amino acids and would undergo putrefaction via similar pathways.

Over 30% of the necromone's detected peak area during chemical analysis are comprised of amino acids, with leucine and alanine comprising more than half (58%) of this fraction. Leucine (2-amino-4-methylpentanoic acid) and alanine (2-aminopropanoic acid) are present in the necromone because shark muscle tissue is used in the extractive process. These amino acids are abundant in nature and would be unlikely to produce a highly specific chemical signal.

Acids constitute more than 12% of the detected peak area of the shark necromone. Most are short-chain carboxylic acids, which are expected putrefaction end products due to the b-scission of the alkoxy radicals formed from unsaturated fatty acids. These short-chain acids also contribute to the characteristic odor of the necromone. Acetic acid (C3), and the isovaleric acids (C5,3-methyl-butanoic acid and 2-methyl-butanoic acid) are the most abundant. Fatty acids were also detected, and these are likely extracted from shark liver.

The known insect necromone oleic acid is also present. The ethyl ester of stearic acid (C18) is present, resulting from the esterification of the acid with the extraction solvent. Capric acid (C10), myristic acid (C14) and palmitic acid (C16) are also found, along with their ethyl esters. These fatty acids are unlikely to produce a highly specific signal because they are ubiquitous and have low solubilities in seawater. A multitude of aldehydes, enals, ketones, and organosulfur products are also identified. These are the result of the degradation of squalene and other unsaturated lipids present in the liver, likely by oxidative pathways.

Matrix 64 may be a water soluble time-release substance with a known dissolution profile such as a hydrogel, microencapsulation, hydroxypropyl methycellulose (HPMC), methylpropylcellulose (MPC), or the like. Other dissolvable matrices such as surfactants, soap-like and chalk-like substances are also possible. It is also within the scope of the invention to use insoluble substances such as acrylics, chitin or various non-dissolvable cartridges such that the repellent must find its way out through the holes.

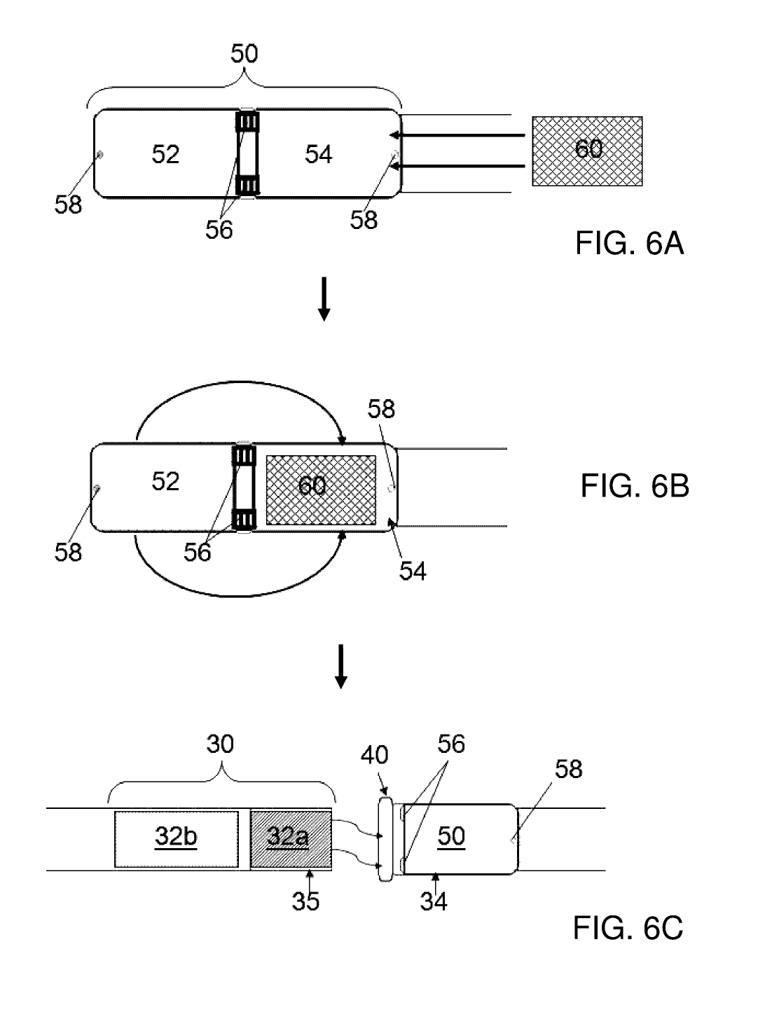

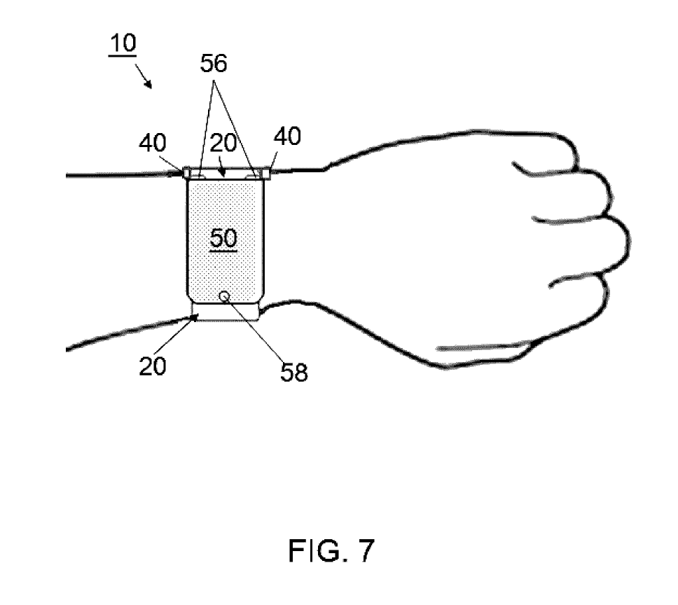

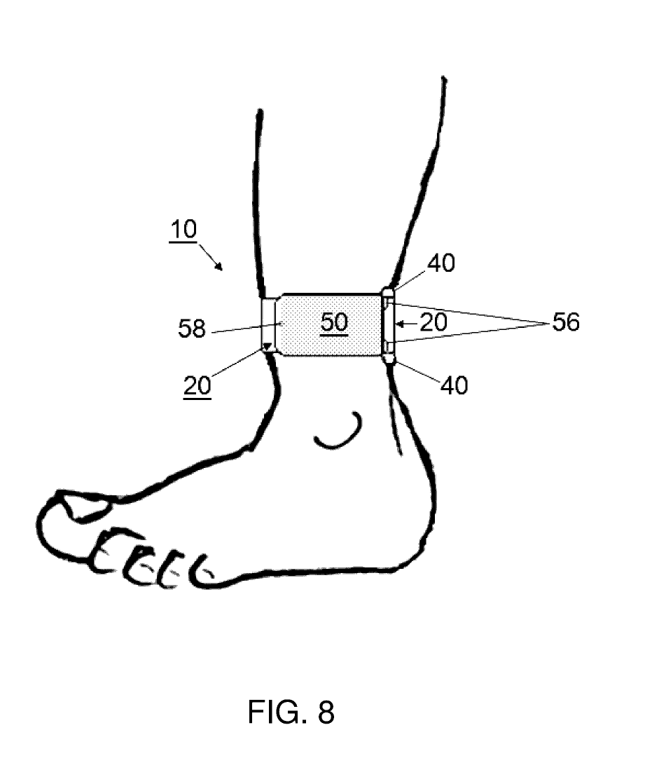

In use, a user opens door 52 to access inside of case 50 and positions refill 60 in base 54 (FIG. 6A). Next the user closes door 52 and engages closure 58 (FIG. 6B). Device 10 is then secured by connecting distal end 35 to proximal end 35 using cinching means 40 and fastening means 30 (FIG. 6C). Device 10 can be attached to an inanimate object such as a life preserver or surfboard, but is preferably attached to the ankle or wrist of a person, as shown in FIGS. 7 and 8 respectively. Attachment is achieved by connecting fastening means such as hook/loop fastener (shown), snaps, buttons, adhesive, buckles, or the like. Device 10 is activated when water flows through apertures 53, dissolves matrix 64, and liquefied repellent 62 and matrix 64 exits case 50. Depleted refills 60 are replaced as needed.

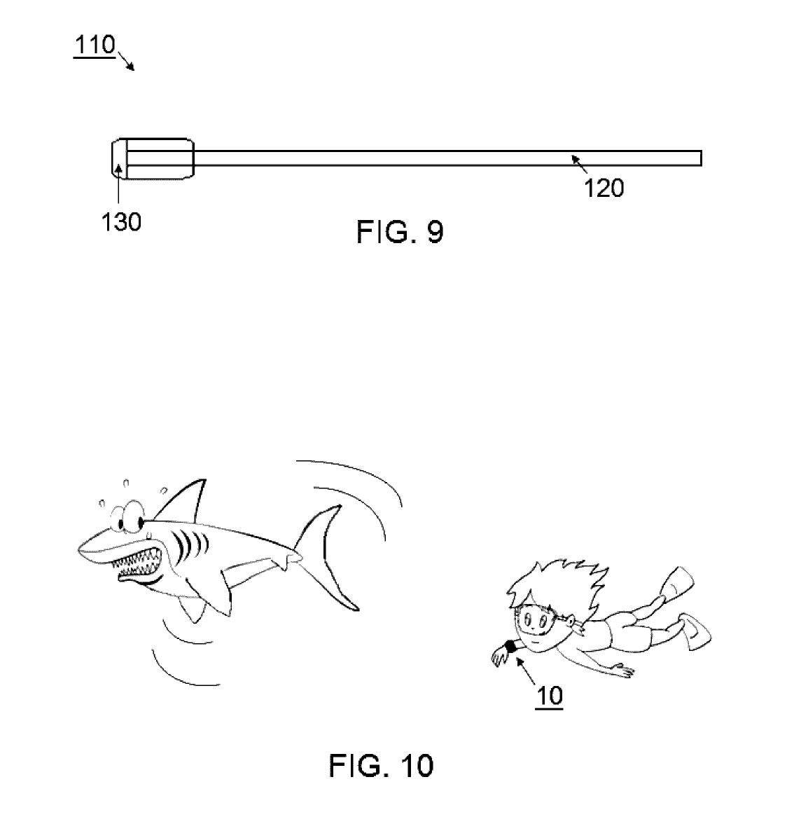

Alternative device 110 is depicted in FIG. 9, and is similar to a conventional anti-flea pet collar, except the band is impregnated with repellant 62 that diffuses out when in contact with water.

A variety of modifications are within the scope of this invention. By way of example, strap 20 could be lengthened so device is worn around leg or mid-section, or worn as a necklace. Case 50 could be used without strap and affixed to inanimate objects or kept in the pocket of a swimmer. It should also be understood that the device could be used as a system for repelling other aquatic animals such as alligators and jellyfish by using refills with the appropriate repellent.

Specifications of certain structures and components of the present invention have been established in the process of developing and perfecting prototypes and working models. These specifications are set forth for purposes of describing an embodiment, and setting forth the best mode, but should not be construed as teaching the only possible embodiment. It should be understood that ranges of values set forth inherently include those values, as well as all increments between. It should also be understood that all specifications, unless otherwise stated or contrary to common sense, are +/−10%.

What is claimed is:

1. A system for preventing aquatic animal attacks comprising:
A. A case including a water permeable door;
B. A strap attached to said case;
C. A fastening means attached to said strap; and
D. A removable refill enclosed in said case, said removable refill including a repellent suspended in a water soluble matrix.

2. The system of claim 1 wherein said case includes a water impermeable base attached to said door.

3. The system of claim 2 wherein said water impermeable base is attached to said door by at least one hinge.

4. The system of claim 1 wherein said water permeable door defines a plurality of apertures.

5. The system of claim 1 wherein said repellent includes putrefied shark tissue extract.

6. The system of claim 5 wherein said putrefied shark tissue extract includes a necromone.

7. The system of claim 1 wherein said water soluble matrix is a time-release matrix.

8. The system of claim 7 wherein said time-release matrix is selected from the group consisting of hydrogel, microencapsulation, hydroxypropyl methycellulose (HPMC), and methylpropylcellulose (MPC).

9. A shark repelling device including:
A. A water permeable case having a central hollow portion;
B. An adjustable strap attached to said case; and
C. A shark necromone within said central hollow portion.

10. The shark repelling device of claim 9 wherein said shark necronome is imbedded in a matrix.

11. The shark repelling device of claim 10 wherein said matrix is water soluble.

12. The shark repelling device of claim 9 wherein said shark necromone is comprised of >30% amino acids.

13. The shark repelling device of claim 12 wherein greater than 50% of said amino acids are a combination of leucine and alanine.

14. The shark repelling device of claim 9 wherein said shark necronome includes 2-amino-4-methylpentanoic acid and 2-aminopropanoic acid.

15. A method of repelling sharks including the steps of:
A. Inserting a first repellent-laden refill into a water permeable case;
B. Allowing water to enter said water permeable case;
C. Allowing water to exit said water permeable case; and
D. Replacing said first repellent-laden refill with a second repellent-laden refill upon depletion of said first repellent-laden refill.

16. The method of claim 15 further including the step of attaching said water permeable case to a human.

17. The method of claim 15 wherein said step of inserting a first repellent-laden refill into a water permeable case includes the step of inserting a first repellent-laden refill containing shark necromone into said water permeable case.
